(19) United States
(12) Patent Application Publication
(10) Pub. No.: US 2024/0217027 A1
(43) Pub. Date: Jul. 4, 2024

(54) SYSTEMS AND METHODS FOR WELDING MOTOR STATOR HAIRPIN WIRES

(71) Applicant: GM GLOBAL TECHNOLOGY OPERATIONS LLC, Detroit, MI (US)

(72) Inventors: Chen ZHOU, Troy, MI (US); Wuhua Yang, Superior Township, MI (US); John S. Agapiou, Rochester Hills, MI (US); Terebara Hughes, Warren, MI (US); Thiagarajan Chidambareswaran, Sterling Heights, MI (US)

(21) Appl. No.: 18/090,102

(22) Filed: Dec. 28, 2022

(51) Int. Cl. B23K 26/03; B23K 26/046; B23K 26/08; B23K 26/21; B23K 37/02

(52) U.S. Cl. CPC B23K 26/032; B23K 26/046; B23K 26/0884; B23K 26/21; B23K 37/0258; B23K 2101/36

(57) ABSTRACT

A system for welding together tips of different wires arranged about a motor stator. A scanner control module is configured to operate a three-dimensional scanner to scan the tips of the different wires and measure alignment of the tips in X, Y, and Z directions of a coordinate plane. A system control module is configured to compare the measured alignment of the tips to a predetermined alignment range, and configured to identify a weld schedule for each of the tips that fall within the predetermined alignment range. A laser welder control module is configured to operate a laser welder to weld together only the tips aligned within the predetermined alignment range in accordance with the weld schedule identified by the system control module.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to systems and methods for welding motor stator hairpin wires.

Electric motors generally include a rotor and a stator. The rotor rotates inside of the stator. The stator includes a plurality of hairpin wires. Each hairpin wire includes two tips. The tips of different hairpins are welded together during manufacturing to form stator windings (the three phases in the stator). The tips are typically welded together with a laser.

### SUMMARY

In a feature, the present disclosure includes a system for welding together tips of different wires arranged about a motor stator. A scanner control module is configured to operate a three-dimensional scanner to scan the tips of the different wires and measure alignment of the tips in X, Y, and Z directions of a coordinate plane. A system control module is configured to compare the measured alignment of the tips to a predetermined alignment range, and configured to identify a weld schedule for each of the tips that fall within the predetermined alignment range. A laser welder control module is configured to operate a laser welder to weld together only the tips aligned within the predetermined alignment range in accordance with the weld schedule identified by the system control module. After welding the acceptably aligned tips, the scanner control module is configured to operate the three-dimensional scanner to scan the welds and measure characteristics of each weld including at least one of height, volume, radius, and weld size. The system control module is configured to compare the measured characteristics of each one of the welds to predetermined weld tolerances to determine whether each one of the welds falls within the predetermined weld tolerances or is in need of repair. For each one of the welds in need of repair, the system control module is configured to identify a best fit repair weld schedule based on the measured characteristics of each one of the welds. The laser welder control module is configured to operate the laser welder to perform a repair weld in accordance with the best fit repair weld schedule for each one of the welds in need of repair.

In further features, a rotary stage control module is in cooperation with a rotary stage that is configured to support the motor stator and rotate the motor stator during scanning and welding. The rotary stage control module is configured to control rotation of the rotary stage to synchronize rotation with the welding and the scanning.

In further features, the scanner control module is configured to operate the three-dimensional scanner to scan the repair welds and measure characteristics of each of the repair welds. The system control module is configured to compare the repair weld characteristics to predetermined repair weld tolerances, and generate an alert identifying any of the repair welds that are outside of the predetermined repair weld tolerances.

In further features, the system control module is configured to generate an alert identifying any of the tips not welded due to falling outside of the predetermined alignment range, and pause the system to permit manual alignment.

In further features, prior to welding, the scanner control module is configured to operate the three-dimensional scanner to measure average heights and height ranges of the tips. The system control module is configured to set heights of the welds based on the average heights and height ranges of the tips of the motor stator.

In further features, prior to welding, the scanner control module is configured to operate the three-dimensional scanner to measure average heights and height ranges of the tips. The system control module is configured to set a height of the laser welder and a focal point of the laser welder based on the average heights and the height ranges of the tips.

In further features, the three-dimensional scanner includes a metrology laser.

In further features, the laser welder is mounted to, and maneuvered by, a robotic arm.

In a feature, the present disclosure includes a method for welding together tips of different wires arranged about a motor stator. The method includes the following: scanning the tips with a three-dimensional scanner prior to welding; measuring alignment of the tips in X, Y, and Z coordinate plane directions; comparing the measured alignment of the tips to a predetermined alignment range; identifying a weld schedule for the tips aligned within the predetermined alignment range; activating a laser welder to weld together only the tips aligned within the predetermined alignment range in accordance with the weld schedule; after welding, scanning the welds with the three-dimensional scanner; measuring characteristics of each of the welds including at least one of height, volume, radius, and weld size; comparing the measured characteristics of each of the welds to predetermined weld tolerances to determine whether each of the welds falls within the predetermined weld tolerances or is in need of repair; for each of the welds in need of repair, identifying a best fit repair weld schedule based on the measured characteristics of each of the welds; and activating the laser welder to perform a repair weld in accordance with the best fit repair weld schedule.

In further features, the method includes generating an alert identifying any of the tips not welded due to falling outside of the predetermined alignment range, and pausing operations to permit manual alignment.

In further features, the method includes, prior to welding, measuring average heights and height ranges of the tips; and during welding, optimizing heights of the welds based on the average heights and height ranges of the tips of the motor stator.

In further features, the method includes performing the scanning with a three-dimensional metrology laser.

In further features, the method includes rotating the motor stator on a rotary stage during the scanning and welding.

In further features, the method includes measuring a distance between the laser welder and each of the tips. The weld schedule for each of the tips includes a focal length setting for the laser welder optimized for the distance between the laser welder and each of the tips.

In further features, the weld schedule includes an optimal height of the three-dimensional scanner relative to the tips, and the laser welder control module is configured to set the laser welder to the optimal height.

In a feature, the present disclosure includes a method for welding together tips of different wires arranged about a motor stator. The method includes the following: scanning the tips with a three-dimensional scanner prior to welding; measuring alignment of the tips in X, Y, and Z coordinate plane directions; comparing the measured alignment of each of the tips to a predetermined alignment range; identifying a weld schedule for each of the tips that fall within the predetermined alignment range; activating a laser welder to weld together only the tips aligned within the predetermined alignment range in accordance with the weld schedule; after welding, scanning the welds with the three-dimensional scanner; measuring characteristics of each of the welds including at least one of height, volume, radius, and weld size; comparing the measured characteristics of each of the welds to predetermined weld tolerances to determine whether each of the welds falls within the predetermined weld tolerances or is in need of repair; for each of the welds in need of repair, identifying a best fit repair weld schedule based on the measured characteristics of each of the welds; and activating the laser welder to perform a repair weld in accordance with the best fit repair weld schedule; scanning the repair welds with the three-dimensional scanner; measuring characteristics of each of the repair welds; comparing the characteristics of each of the repair welds to predetermined repair weld tolerances; and generating an alert identifying any of the repair welds that are outside of the predetermined repair weld tolerances.

In further features, the method includes measuring a distance between the laser welder and each tips of the motor stator. The weld schedule for each of the tips includes a focal length setting for the laser welder optimized for the distance between the laser welder and each of the tips.

In further features, the method includes generating an alert identifying any tips not welded due to falling outside of the predetermined alignment range, and pausing operations to permit manual alignment.

In further features, the method includes performing the scanning with a three-dimensional metrology laser.

In further features, the method includes rotating the motor stator on a rotary stage during the scanning and welding.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of an exemplary system in accordance with the present disclosure for welding stator hairpin wires;

FIG. 2 illustrates a motor stator including an exemplary arrangement of hairpin wires (although only four groups of wires are illustrated, the illustrated arrangements repeat continuously about the stator);

FIG. 3 illustrates an exemplary control system for the system of FIG. 1;

FIG. 4A is a side view of an exemplary pair of hairpin wire tips of the motor stator prior to welding;

FIG. 4B is a top view of another exemplary pair of hairpin wire tips of the motor stator prior to welding;

FIG. 4C is a top view of an additional exemplary pair of hairpin wire tips of the motor stator prior to welding;

FIG. 5A illustrates an exemplary weld between a pair of hairpin wire tips;

FIG. 5B illustrates another exemplary weld between wire tips;

FIG. 5C illustrates an additional exemplary weld between wire tips;

FIG. 5D is a side view of another exemplary weld between wire tips;

FIG. 6 illustrates an exemplary method in accordance with the present disclosure for welding pairs of hairpin wire tips of the motor stator;

FIG. 7A illustrates another exemplary method in accordance with the present disclosure for welding pairs of hairpin wire tips; and

FIG. 7B is a continuation of FIG. 7A.

In the drawings, reference numbers may be reused to identify similar and/or identical elements.

### DETAILED DESCRIPTION

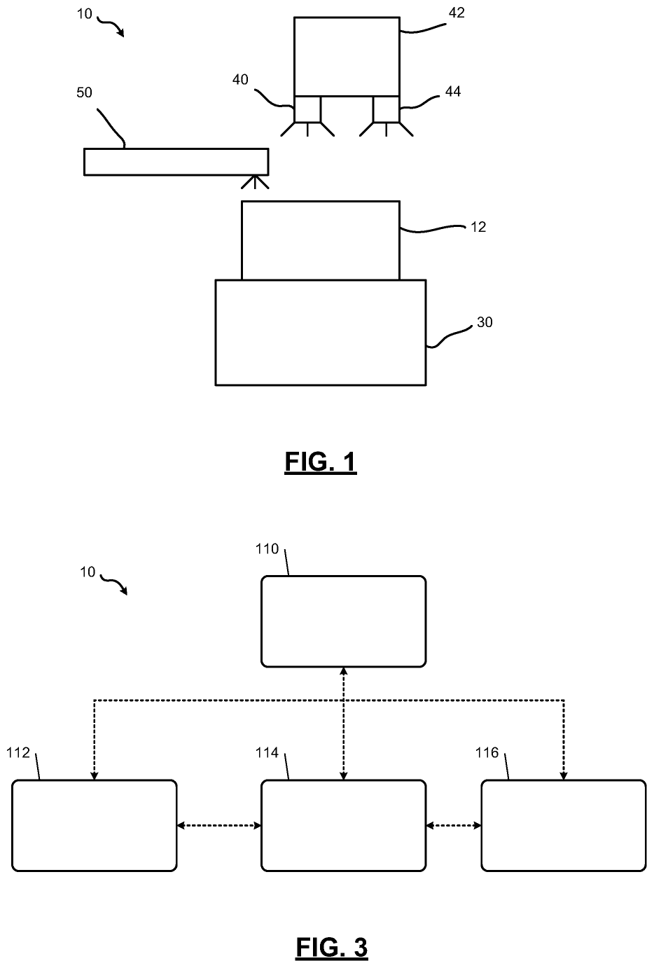

FIG. 1 illustrates an exemplary system 10 in accordance with the present disclosure for welding hairpin wires of a motor stator 12. The stator 12 is configured for use in any suitable electric motor, such as a motor for a battery electric vehicle (BEV). The stator 12 may be installed in any suitable non-vehicular electric motor as well. Thus, the system 10 and the present disclosure in general is applicable to both vehicular and non-vehicular applications.

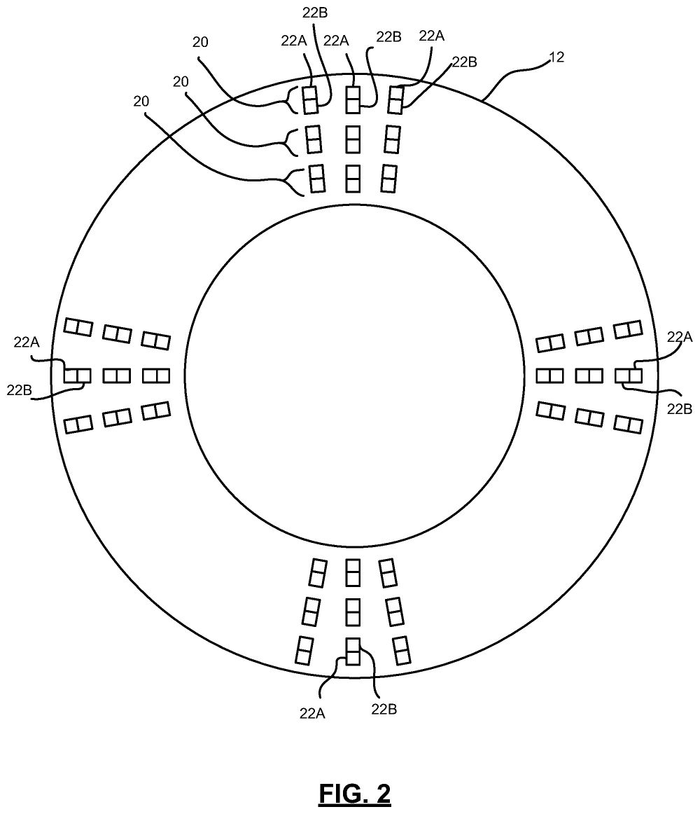

With additional reference to FIG. 2, the stator 12 includes a plurality of hairpin wires. The hairpin wires are arranged in pairs 20 that are adjacent to one another. The pairs 20 are arranged around the stator 12. Each pair 20 of hairpin wires terminates at a first tip 22A of a first hairpin wire and a second tip 22B of a second hairpin wire. Thus, the first tip 22A and the second tip 22B are of different hairpin wires. The first tip 22A of the first hairpin wire is located adjacent to the tip 22B of the second hairpin to form a pair 20 that forms the continuity of a phase, which consists of a large number of hairpins distributed around the stator 12.

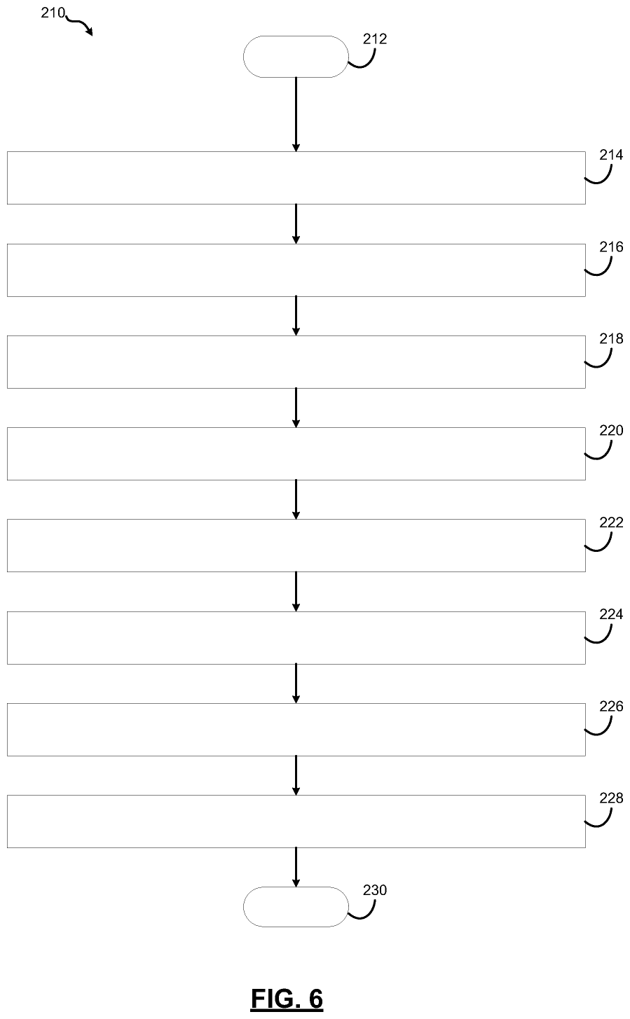

The wire pairs 20 are arranged about an entire circumference of the stator 12. Although FIG. 2 illustrates only four regions of wire pairs 20 (at 1, 3, 6, and 9 o'clock) with gaps between the four regions, the wire pairs 20 are present in the gaps such that the wire pairs 20 are arranged uninterrupted about the circumference of the stator 12 across the gaps. During manufacturing, the wire pairs 20 are seated in the stator with the first tips 22A of one hairpin and the second tip 22B of another hairpin unwelded. After the wire pairs 20 are arranged about the stator 12, the first tip 22A and the second tip 22B of each wire pair 20 are welded together in accordance with the present disclosure. FIG. 5 illustrates an exemplary weld 24.

Returning to FIG. 1, the system 10 further includes a rotary stage 30, which is configured to support the stator 12 and rotate the stator 12. Opposite to the rotary stage 30 and the stator 12 is a welding laser 40. The welding laser 40 is mounted and maneuvered in any suitable manner during welding. For example, the laser 40 may be mounted to a robotic arm 42. Also mounted to the robotic arm 42 may be a sensor 44, which is configured to position the robotic arm 42 and the welding laser 40 relative to the wire pairs 20 during welding of the first tips 22A and the second tips 22B from different hairpin wires.

The rotary stage 30 may be any suitable support mechanism configured to rotate the stator 12 during welding and scanning. For example, the rotary stage 30 may include an AKD Series servo drive offered by Kollmorgen Corporation of Radford, Virginia. The welding laser 40 may be any suitable welding laser, such as any suitable welding laser offered by Trumpf Laser GmbH+Co. KG of Germany, for example. The robotic arm 42 may be any suitable robotic arm, such as any suitable robotic arm offered by FANUC America Corporation of Rochester Hills, Michigan, for example.

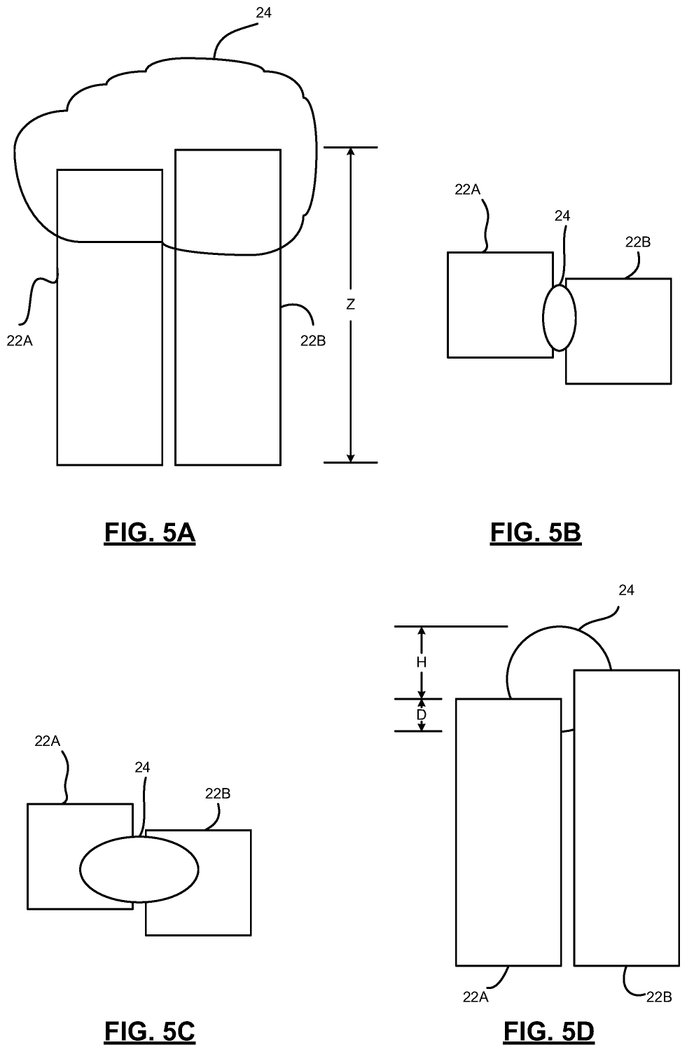

Mounted over the rotary stage 30, and the stator 12 when present, is a three-dimensional (3D) scanner 50. The 3D scanner 50 is a laser scanner configured to measure three-dimensional properties of the hairpin wire tips 22A and 22B. For example, the 3D scanner 50 is configured to measure the height of each first tip 22A and each second tip 22B in the Z direction (see FIG. 4A). The scanner 50 is also configured to measure the alignment (or misalignment) between the first tip 22A and the second tip 22B of each one of the wire pairs 20 (see FIGS. 4A-4C, for example). The scanner 50 may be any suitable laser metrology scanner. The scanner 50 may include any suitable laser profiler, such as the Keyence LJ-8000E 3D Metrology Laser profiler offered by Keyence Corporation of America, of Itasca, IL, for example. However, it can also be any suitable visual camera system that is capable of recording the top and side views of the wire pairs 20.

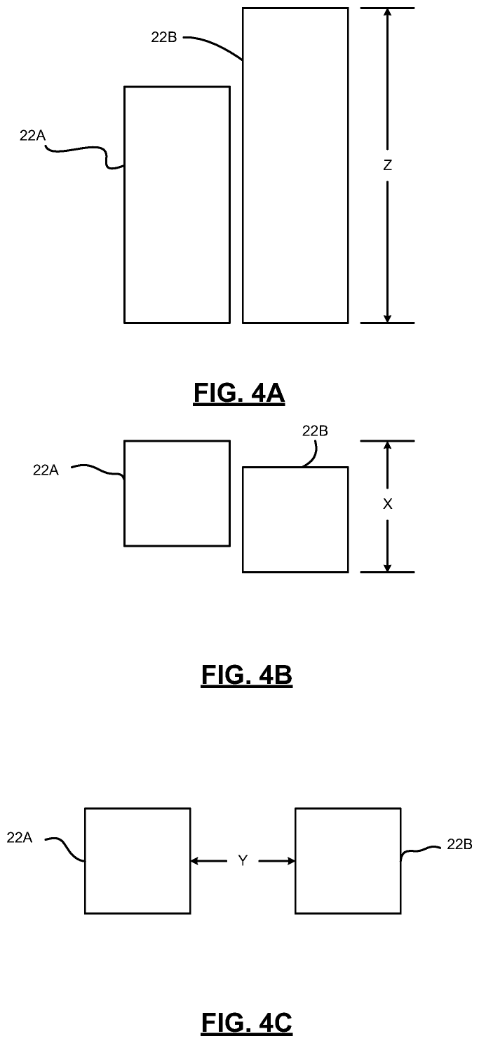

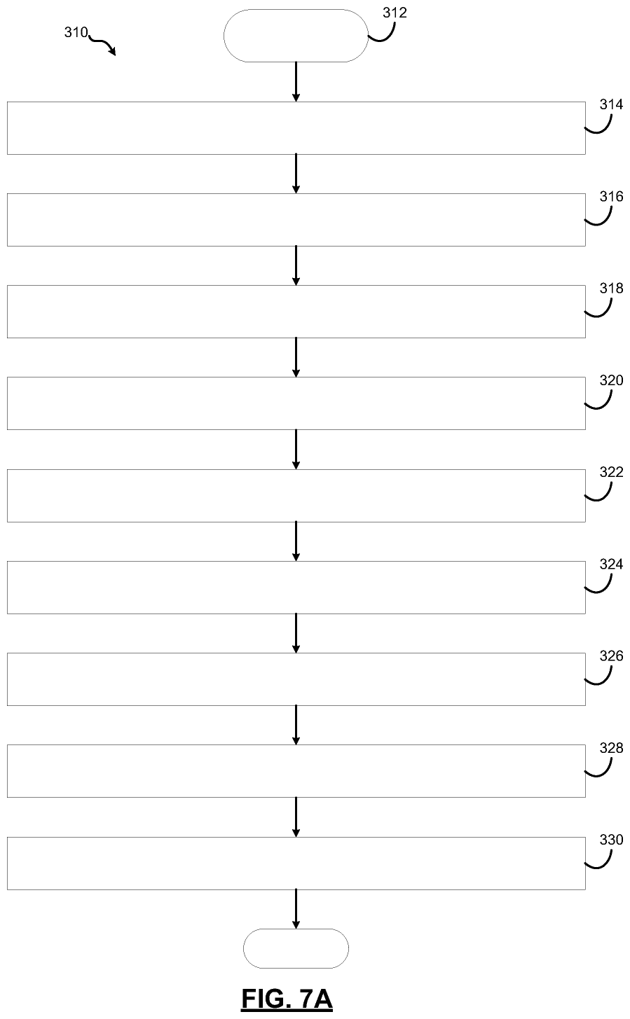

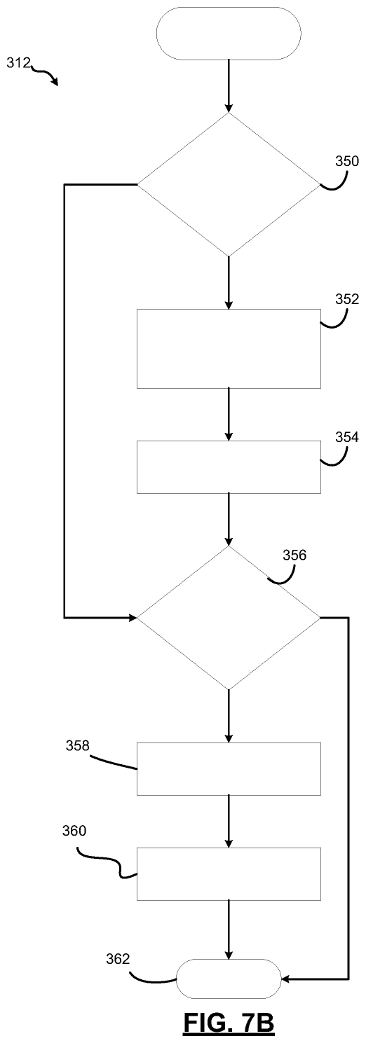

With reference to FIG. 3, the system 10 further includes a system control module 110, a rotary stage control module 112, a 3D scanner control module 114, and a laser welder control module 116. The control modules 110, 112, 114, and 116 are configured to control the components of FIG. 1 and communicate with each other to carry out the methods of the present disclosure, such as the methods 210 and 310 described herein and illustrated in FIGS. 6, 7A, and 7B. For example, the system control module 110 initiates operation of the system 10 by instructing the rotary stage control module 112 to start the rotary stage 30 after the stator 12 is properly positioned on the rotary stage 30. The rotary stage control module 112 is in communication with the rotary stage 30 to control rotation of the rotary stage 30 to position the stator 12 as needed for welding by the welding laser 40 and scanning by the scanner 50.

The rotary stage control module 112 is in communication with the 3D scanner control module 114. The 3D scanner control module 114 is in communication with the 3D scanner 50 to operate the scanner 50 to scan and image three-dimensionally each one of the first tips 22A and each one of the second tips 22B, and to image each one of the welds 24 between the tips 22A, 22B. More specifically, the 3D scanner control module 114 is configured to operate the scanner 50 to measure the heights, average heights, and height ranges in the Z-direction of all of the tips 22A, 22B. For each wire pair 20, the 3D scanner control module 114 is configured to operate the scanner 50 to measure and record relative positions of the first tip 22A and the second tip 22B to identify height differences in the Z-direction, to identify misalignment (such as in the X-direction, for example), and to identify outsized gaps between the tips 22A, 22B (such as in the Y-direction, for example).

FIGS. 4A-4C illustrate examples of misalignment of the tips 22A, 22B that the scanner 50 is configured to identify. FIG. 4A illustrates a first tip 22A and a second tip 22B of an exemplary wire pair 20 having different heights in the Z-direction. FIG. 4B illustrates another exemplary wire pair 20 having a first tip 22A and a second tip 22B that are misaligned in the X-direction. FIG. 4C illustrates an additional exemplary wire pair 20 having a first tip 22A and a second tip 22B spaced apart in the Y-direction beyond a predetermined acceptable distance. With reference to FIG. 5, the scanner control module 114 is further configured to operate the scanner 50 to measure characteristics of each weld 24 (and any necessary repair welds), such as the weld height, volume, radius, and size.

The laser welder control module 116 is in communication with the welding laser 40 to form the welds 24 between the tips 22A, 22B, and to form repair welds if needed. The laser welder control module 116 operates the welding laser 40 to form the welds 24 and repair welds in accordance with a welding schedule and a repair weld schedule, which include settings, parameters, and other commands for the welding laser 40 to follow. The welding schedule and the repair weld schedule are selected by the system control module 110 as described below.

FIGS. 5B, 5C, and 5D illustrate an exemplary profile of the weld 24 on an exemplary wire pair 20. The weld 24 covers the join section between the wire tips 22A and 22B. The weld depth D (FIG. 5D) between the tips 22A and 22B supports the mechanical load required for the wire pair 22. Because it is hard to measure the depth D of the weld 24 between the tips 22A, 22B of a pair 20, the visual appearance of the weld bead profile, such as the height H (FIG. 5D) and the cross-section of the weld bead is used as a parameter for quality evaluation. Different weld schedules are configured for various instances of ΔZ, ΔX, ΔY (Gap) to achieve satisfactory welding results. The ΔZ defines which of the wire tips 22A, 22B is taller. The ΔX defines the misalignment and the direction of misalignment to illustrate the angular position of the centroid for the tips 22A, 22B of a pair 20. The ΔY defines the gap between the tips 22A, 22B of a pair 20. Several weld schedules are available to the system control module 110 to cover all the possible acceptable misalignments of the two tips 22A and 22B. The height of the tips 22A, 22B allows the adjustment of the focal point and beam path trajectory of the laser welder 40 for different wire pairs 20 in a stator 12 to better optimize the welding schedules and reduce the welding quality variability.

FIG. 6 illustrates an exemplary method 210 in accordance with the present disclosure for forming the welds 24 between the tips 22A, 22B of each wire pair 20. The method 210 is generally executed by the system control module 110, the rotary stage control module 112, the 3D scanner control module 114, and the laser welder control module 116 as explained in detail herein. The method 210 is initiated by the system control module 110 at block 212 in response to an input by an operator, such as by way of a user interface. From block 212, the method 210 proceeds to block 214, where the system control module 110 transmits a command to the rotary stage control module 112 to activate the rotary stage 30 if the stator 12 is seated thereon. Once activated, the rotary stage 30 rotates the stator 12. At this point in the method 210, the stator 12 includes the wire pairs 20 with unwelded tips 22A, 22B.

From block 214, the method 210 proceeds to block 216. At block 216, the 3D scanner control module 114 operates the 3D scanner 50 to scan the pairs of tips 22A and 22B of each of the pairs 20 as the stator 12 is rotated by the rotary stage 30. The 3D scanner control module 114 and the rotary stage control module 112 work in conjunction to rotate the stator 12 to position each one of the wire pairs 20 within range of the 3D scanner 50 for imaging. The scanning process can be initiated in response to a command received by the 3D scanner control module 114 from the rotary stage control module 112 and/or the system control module 110. The system 10 may also be configured such that the 3D scanner 50 begins to scan in response to motion of the rotary stage 30. From block 216, the method 210 proceeds to block 218.

At block 218, the 3D scanner control module 114 operates the 3D scanner 50 to measure and optionally record the heights of all of the first tips 22A and the heights of all of the second tips 22B. The scanner control module 114 also determines the average heights across all of the tips 22A, 22B, identifies the lowest tip 22A, 22B, and identifies the highest tip 22A, 22B. The heights are measured in the Z-direction (see FIG. 4A, for example), and the heights are measured either from a lamination top plane or a reference post. The heights in the Z-direction may be used, for example, to determine the lowest tip 22A, 22B in order to trim all of the tips 22A, 22B to prepare them for welding. The heights in the Z-direction may also be used to adjust the focus of the welding laser 40 to within the height of the hairpin tips 22A, 22B. The system control module 110 (or the module 114, or the module 116) will note which tips 22A, 22B are above or below average in order to make further adjustments of the welding head distance during the welding cycle.

At block 220, the 3D scanner control module 114 operates the 3D scanner 50 to measure and optionally record the position of each one of the tips 22A, 22B in the X, Y, and Z directions. The scanner control module 114 also, for each one of the pairs 20, calculates the difference in alignment between the tips 22A, 22B in the X, Y, and Z directions to arrive at ΔX, ΔY, & ΔZ dimensions for the tips 22A, 22B of each pair 20. FIG. 4A illustrates an example of a difference in alignment in the Z direction. FIG. 4B illustrates an example of a difference in alignment in the X direction. FIG. 4C illustrates an example of a difference in alignment in the Y direction resulting in a relatively large gap between the tips 22A, 22B. Data gathered by the 3D scanner control module 114 is input to the system control module 110 for further processing. From block 220, the method 210 proceeds to block 222.

At block 222, the system control module 110 assesses the alignment data received from the 3D scanner control module 114 for each pair 20 to determine whether alignment of the tips 22A, 22B for each pair 20 is within a predetermined acceptable range for welding. To do this, the system control module 110 compares the measured ΔX, ΔY, & ΔZ dimensions for the tips 22A, 22B of each pair 20 to predetermined welding schedules saved in memory of the system control module 110, or accessible to the system control module 110. The predetermined schedules include acceptable ΔX, ΔY, & ΔZ dimensions arrived at through experimentation, and corresponding welding parameters for the welding laser 40 to use to form the welds 24. If the measured ΔX, ΔY, & ΔZ dimensions are within the predetermined acceptable ranges, then at block 226 the system control module 110 transmits the corresponding best fit weld schedule to the laser welder control module 116. At block 228, the laser welder control module 116 controls the welding laser 40 to form the welds. Only the pairs 20 with tips 22A, 22B that have acceptable ΔX, ΔY, & ΔZ dimensions are welded.

Included in the welding schedule inputs to the laser welder 116 is the average Z-height of the tips 22A, 22B. If the Z-height is not within range of the welding focus of the welding laser 40 (e.g., +/−2 mm), the laser welder control module will adjust the head of welding laser 40 to an appropriate Z-height in relation to the tips 22A, 22B. After the acceptably aligned tips 22A, 22B are welded, the method 210 stops at block 230.

FIGS. 7A and 7B illustrate an exemplary method 310 in accordance with the present disclosure for post-weld processing. The method 310 may be used to assess the welds 24 formed in accordance with the method 210, or any other suitable method. The method 310 begins at start block 312. The method 310 is commenced by the control system 110 automatically upon detection of the conclusion of the method 210 at block 230, or in response to a manual input by an operator. From block 312, the method 310 proceeds to block 314.

At block 314, the system control module 110 transmits a command to the rotary stage control module 112, and in response the rotary stage control module 112 transmits a command to the rotary stage 30 to rotate the stator 12. The rotation of the rotary stage 30 triggers activation of the 3D scanner 50. Alternatively, the 3D scanner control module 114 may receive an activation signal from the rotary stage control module 112 or the system control module 110.

At block 316, the 3D scanner control module 114 operates the 3D scanner 50 to scan each weld 24 of each wire 20 and optionally record images thereof. Based on the scanned images, at block 318 the 3D scanner control module measures characteristics of each weld 24, such as, for example, the height, volume, radius, and size of each weld. The measured weld characteristics are input to the system control module 110.

At block 320, the system control module 110 evaluates the weld characteristics to assess the quality of each weld 24, and specifically whether each weld 24 is acceptable or in need of repair. To do this, the system control module 110 compares the measured weld characteristics of each weld 24 to predetermined acceptable weld tolerances. The predetermined acceptable weld tolerances are saved in memory of the system control module 110, or at a location accessible to the system control module 110. If the measured weld characteristics are within the predetermined acceptable weld tolerances, then the particular weld 24 is deemed acceptable. If the measured weld characteristics are outside of the predetermined acceptable tolerances, then the particular weld 24 is determined to be in need of repair.

The welds 24 may be categorized based on size, such as with a size ranking number. For example, a full weld 24 that entirely covers distal ends of both the first tip 22A and the second tip 22B is assigned size 10. A weld that covers slightly less than an entirety of the distal ends of the tips 22A, 22B is assigned a size 9, and so on. Acceptable welds may be classified as such down to a size 7. An unacceptable weld that only partially covers the tips 22A, 22B may be classified as a size 6. Varying degrees of unacceptable welds may be classified from size 5 down to size 1, with size 1 having no weld at all. For example, the width and length of the weld bead 24 is related to the width of the wire tips 22A, 22B and the length of the wire pair to properly classify the weld beads. The height of the weld bead defines the shearing cross-section of the weld 24 in case the weld depth is insufficient (since it is hard to measure). The height of the weld bead 24 at the join location of a pair 20 affects the pull load for the weld. The size numbers may be used to assess performance of the welding process for statistical analysis and future improvements. An AI algorithm may also be used to further categorize weld quality of the profile and whether weld bead parameters are outside of an existing template.

At block 322, for each weld 24 determined to be in need of repair, the system control module 110 selects a best fit predetermined repair weld schedule from a plurality of repair schedules based on the weld characteristics measured at block 318 and the assigned weld size number. The repair weld schedules are saved in memory of the system control module 110, or saved at a location accessible to the system control module 110. Each repair weld schedule includes repair weld parameters for operating the welding laser 40 to perform a repair weld on the weld 24 determined to be unacceptable. At block 324, the system control module 110 transmits the selected best fit repair weld schedule to the laser welder control module 116. Upon receipt of the repair weld schedule and an instruction to carry out the repair weld, the laser welder control module 116 activates the welding laser 40. The laser welder control module 116 instructs the welding laser 40 to perform the repair weld based on the welding parameters of the repair weld schedule.

After the repair welds are complete, the method 310 proceeds to block 326. At block 326, the system control module 110 instructs the 3D scanner control module 114 to activate the 3D scanner 50 to scan the repair welds and optionally record images thereof. At block 328, the 3D scanner control module 114 measures characteristics of each repair weld, such as the height, volume, radius, and weld size, for example. The repair weld characteristics are input to the system control module 110. At block 330, the system control module 110 compares the repair weld characteristics to predetermined acceptable weld tolerances to determine whether the repair welds are acceptable. From block 330, the method 310 proceeds to block 350 of FIG. 7B.

At block 350, if the measured repair weld characteristics are within the predetermined acceptable tolerances, then the method 310 proceeds to block 356. If the measured repair weld characteristics are not within acceptable tolerances, then the method 310 proceeds to block 352. At block 352, the system control module 110 generates an operator alert and pauses operations to permit manual evaluation of any repair weld that is outside of predetermined acceptable tolerances. The alert may be any suitable audible and/or visual alert to an operator of the system 10. Based on the manual evaluation, the operator may input custom repair weld parameters for the laser welder control module 116 to use to execute another repair weld. The operator may also manually select a different predetermined repair weld schedule. The laser welder control module 116 then operates the welding laser 40 to carry out an additional repair weld.

At block 356, the system control module 110 checks for unwelded pairs 20, which were not previously welded because the tips 22A, 22B were so far misaligned that an acceptable weld would not be possible. If there are no unwelded pairs 20, then the method 310 ends at block 362. If unwelded pairs 20 remain, then the method 310 proceeds to block 358. At block 358 the system control module 110 notifies the operator of the unwelded pair(s) 20, and pauses operations to allow the operator to perform manual alignment. After manual alignment, the method 310 proceeds to block 360, where the manually aligned pairs 20 are welded in accordance with the method 210. From block 360, the method 310 ends at block 362.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python@.

What is claimed is:

1. A system for welding together tips of different wires arranged about a motor stator, the system comprising:
a scanner control module configured to operate a three-dimensional scanner to scan the tips of the different wires and measure alignment of the tips in X, Y, and Z directions of a coordinate plane;
a system control module configured to compare the measured alignment of the tips to a predetermined alignment range, and configured to identify a weld schedule for each of the tips that fall within the predetermined alignment range; and
a laser welder control module configured to operate a laser welder to weld together only the tips aligned within the predetermined alignment range in accordance with the weld schedule identified by the system control module;
wherein, after welding the acceptably aligned tips:
the scanner control module is configured to operate the three-dimensional scanner to scan the welds and measure characteristics of each weld including at least one of height, volume, radius, and weld size;
the system control module is configured to compare the measured characteristics of each one of the welds to predetermined weld tolerances to determine whether each one of the welds falls within the predetermined weld tolerances or is in need of repair;
for each one of the welds in need of repair, the system control module is configured to identify a best fit repair weld schedule based on the measured characteristics of each one of the welds; and
the laser welder control module is configured to operate the laser welder to perform a repair weld in accordance with the best fit repair weld schedule for each one of the welds in need of repair.

2. The system of claim 1, further comprising a rotary stage control module in cooperation with a rotary stage that is configured to support the motor stator and rotate the motor stator during scanning and welding, the rotary stage control module configured to control rotation of the rotary stage to synchronize rotation with the welding and the scanning.

3. The system of claim 1, wherein:
the scanner control module is further configured to operate the three-dimensional scanner to scan the repair welds and measure characteristics of each of the repair welds; and
the system control module is further configured to compare the repair weld characteristics to predetermined repair weld tolerances, and generate an alert identifying any of the repair welds that are outside of the predetermined repair weld tolerances.

4. The system of claim 1, wherein the system control module is further configured to generate an alert identifying any of the tips not welded due to falling outside of the predetermined alignment range, and pause the system to permit manual alignment.

5. The system of claim 1, wherein, prior to welding:
the scanner control module is configured to operate the three-dimensional scanner to measure average heights and height ranges of the tips; and
the system control module is configured to set heights of the welds based on the average heights and height ranges of the tips of the motor stator.

6. The system of claim 1, wherein, prior to welding:
the scanner control module is configured to operate the three-dimensional scanner to measure average heights and height ranges of the tips; and
the system control module is configured to set a height of the laser welder and a focal point of the laser welder based on the average heights and the height ranges of the tips.

7. The system of claim 1, wherein the three-dimensional scanner includes a metrology laser.

8. The system of claim 1, wherein the laser welder is mounted to, and maneuvered by, a robotic arm.

9. A method for welding together tips of different wires arranged about a motor stator, the method comprising:
scanning the tips with a three-dimensional scanner prior to welding;
measuring alignment of the tips in X, Y, and Z coordinate plane directions;
comparing the measured alignment of the tips to a predetermined alignment range;
identifying a weld schedule for the tips aligned within the predetermined alignment range;
activating a laser welder to weld together only the tips aligned within the predetermined alignment range in accordance with the weld schedule;
after welding, scanning the welds with the three-dimensional scanner;
measuring characteristics of each of the welds including at least one of height, volume, radius, and weld size;
comparing the measured characteristics of each of the welds to predetermined weld tolerances to determine whether each of the welds falls within the predetermined weld tolerances or is in need of repair;
for each of the welds in need of repair, identifying a best fit repair weld schedule based on the measured characteristics of each of the welds; and
activating the laser welder to perform a repair weld in accordance with the best fit repair weld schedule.

10. The method of claim 9, further comprising generating an alert identifying any of the tips not welded due to falling outside of the predetermined alignment range, and pausing operations to permit manual alignment.

11. The method of claim 9, further comprising:
prior to welding, measuring average heights and height ranges of the tips; and
during welding, optimizing heights of the welds based on the average heights and height ranges of the tips of the motor stator.

12. The method of claim 9, further comprising performing the scanning with a three-dimensional metrology laser.

13. The method of claim 9, further comprising rotating the motor stator on a rotary stage during the scanning and welding.

14. The method of claim 9, further comprising measuring a distance between the laser welder and each of the tips;
wherein the weld schedule for each of the tips includes a focal length setting for the laser welder optimized for the distance between the laser welder and each of the tips.

15. The method of claim 9, wherein the weld schedule includes an optimal height of the three-dimensional scanner relative to the tips, and the laser welder control module is configured to set the laser welder to the optimal height.

16. A method for welding together tips of different wires arranged about a motor stator, the method comprising:
scanning the tips with a three-dimensional scanner prior to welding;
measuring alignment of the tips in X, Y, and Z coordinate plane directions;
comparing the measured alignment of each of the tips to a predetermined alignment range;
identifying a weld schedule for each of the tips that fall within the predetermined alignment range;
activating a laser welder to weld together only the tips aligned within the predetermined alignment range in accordance with the weld schedule;
after welding, scanning the welds with the three-dimensional scanner;
measuring characteristics of each of the welds including at least one of height, volume, radius, and weld size;
comparing the measured characteristics of each of the welds to predetermined weld tolerances to determine whether each of the welds falls within the predetermined weld tolerances or is in need of repair;
for each of the welds in need of repair, identifying a best fit repair weld schedule based on the measured characteristics of each of the welds; and
activating the laser welder to perform a repair weld in accordance with the best fit repair weld schedule;
scanning the repair welds with the three-dimensional scanner;
measuring characteristics of each of the repair welds;
comparing the characteristics of each of the repair welds to predetermined repair weld tolerances; and
generating an alert identifying any of the repair welds that are outside of the predetermined repair weld tolerances.

17. The method of claim 16, further comprising measuring a distance between the laser welder and each tips of the motor stator;
wherein the weld schedule for each of the tips includes a focal length setting for the laser welder optimized for the distance between the laser welder and each of the tips.

18. The method of claim 16, further comprising generating an alert identifying any tips not welded due to falling outside of the predetermined alignment range, and pausing operations to permit manual alignment.

19. The method of claim 16, further comprising performing the scanning with a three-dimensional metrology laser.

20. The method of claim 16, further comprising rotating the motor stator on a rotary stage during the scanning and welding.
